(19) United States
(12) Patent Application Publication
(10) Pub. No.: US 2007/0006070 A1
(43) Pub. Date: Jan. 4, 2007

(54) Joining units of work based on complexity metrics

(75) Inventors: Randall Paul Baartman, Rochester, MN (US); Steven Joseph Branda, Rochester, MN (US); Surya V. Duggirala, Eagan, MN (US); John Joseph Stecher, Rochester, MN (US); Robert Wisniewski, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/171,714

(22) Filed: Jun. 30, 2005

(51) Int. Cl. G06F 17/00

(52) U.S. Cl. 715/513

(57) ABSTRACT

A method, apparatus, system, and signal-bearing medium that, in an embodiment, determine units of work in a page, join selected pairs of the units of work with lowest complexity metrics until all of the units of work have complexity metrics that are less than a threshold. The joining is subject to rules of a dependency graph, which indicates data dependency relationships of the units of work. The selected joined pairs are then encapsulated into a processing unit, which is sent to multiple grid servers. Responses from the grid servers are used to assemble dynamic content into the page. In an embodiment, the complexity metrics are then modified based on an exponential moving average of responses times of the units of work. In this way, in an embodiment, the performance of assembling the page may be increased.

### FIELD

This invention generally relates to computer systems and more specifically relates to joining units of work from a page based on complexity metrics for the units of work.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated computer software has evolved to take advantage of the higher performance of the hardware, resulting in computer systems today that are much more powerful than just a few years ago.

Years ago, computer systems were stand-alone devices that did not communicate with each other. But today, computers are increasingly connected via networks, such as the Internet or networks internal to a company or organization. When connected via a network, one computer, often called a client, may request services from another computer, often called a server. In response to a request from a client, one way that a server may return a response is in the form of a page. Pages may be either static or dynamic. In a static page, the contents of the page do not change in response to requests from clients; for example, every request for the same page retrieves the same content. In contrast, the contents of dynamic pages may change depending on the request from the client; for example, a dynamic page may include an embedded database query, which when executed retrieves different data to embed in the page, depending on the contents of the database or the particular query parameters.

One technology for providing dynamic pages is called a Java Server Page (JSP), which is a scripting technology for controlling the content or appearance of pages through the use of servlets. Servlets are programs that are specified or dynamically embedded in the page and which execute to modify the page and create dynamic content within the page before the page is sent to the requesting client. Examples of dynamic content include the results of database queries. The dynamic scripting capability of JSPs works in tandem with the HTML (Hypertext Markup Language) code, which specifies the appearance of the static elements of the page—the actual design and display appearance of the page. Thus, the dynamic page logic of the JSPs is separated from the static elements to help make the HTML more functional.

The processing required to execute the servlets and create the dynamic content of a page may be quite extensive, which may delay the sending the completed page to the requesting client. Hence, what is needed is a technique for increasing the performance of the process for constructing a dynamic page.

### SUMMARY

A method, apparatus, system, and signal-bearing medium are provided that, in an embodiment, determine units of work in a page, join selected pairs of the units of work with lowest complexity metrics until all of the units of work have complexity metrics that are less than a threshold. The joining is subject to rules of a dependency graph, which indicates data dependency relationships of the units of work. The selected joined pairs are then encapsulated into a processing unit, which is sent to multiple grid servers. Responses from the grid servers are used to assemble dynamic content into the page. In an embodiment, the complexity metrics are then modified based on an exponential moving average of responses times of the units of work. In this way, in an embodiment, the performance of assembling the page may be increased.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example page, according to an embodiment of the invention.

FIG. 3 depicts a block diagram of example unit of work complexity metrics, according to an embodiment of the invention.

FIG. 4 depicts a block diagram of an example dependency graph, according to an embodiment of the invention.

FIG. 5 depicts a flowchart of example processing for a compiler, according to an embodiment of the invention.

FIG. 6 depicts a flowchart of example processing for handling a request, according to an embodiment of the invention.

FIG. 7 depicts a flowchart of example processing for assembling a page, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

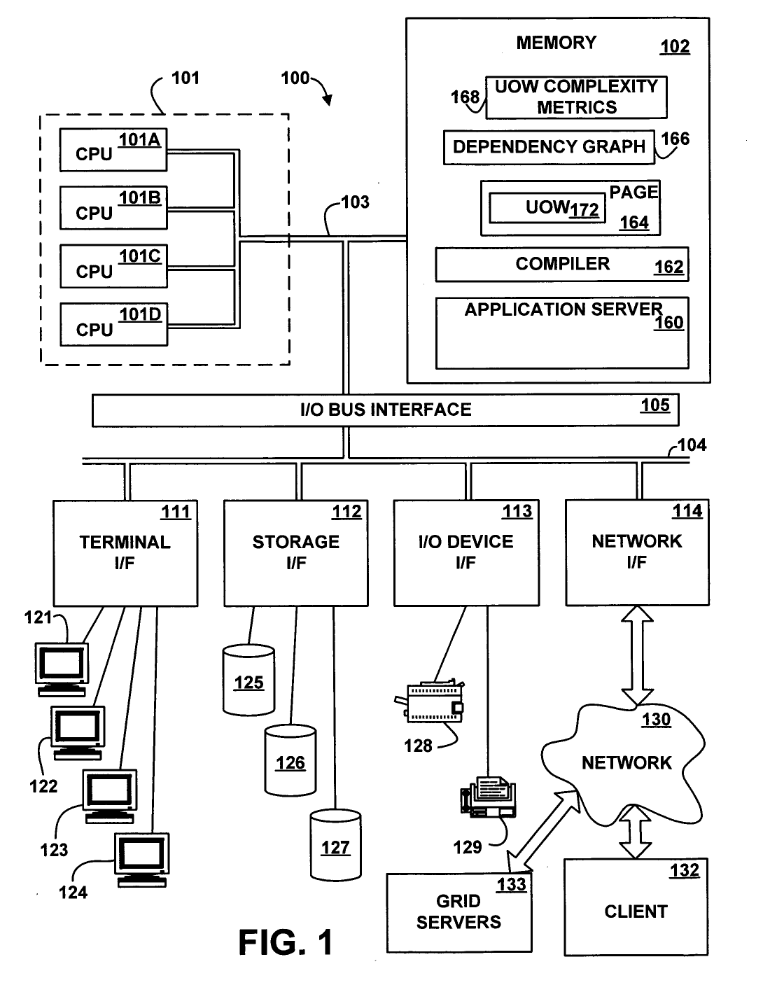

Referring to the Drawings, wherein like numbers denote like parts throughout the several views, FIG. 1 depicts a high-level block diagram representation of a computer system 100 connected via a network 130 to a client 132 and grid servers 133, according to an embodiment of the present invention. The terms “computer,” “client,” and “server” are used for convenience only, and an electronic device that acts as a server in one embodiment may act as a client in another embodiment, and vice versa. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, the main memory 102 may exist in multiple levels of caches, and these caches may be further divided by function, so that one cache holds instructions while another holds non-instruction data, which is used by the processor or processors. The main memory 102 may be further distributed and associated with different CPUs or sets of CPUs, as is known in any of various so-called non-uniform memory access (NUMA) computer architectures.

The main memory 102 includes an application server 160, a compiler 162, a page 164, a dependency graph 166, and unit of work complexity metrics 168. Although the application server 160, the compiler 162, the page 164, the dependency graph 166, and the unit of work complexity metrics 168 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the application server 160, the compiler 162, the page 164, the dependency graph 166, and the unit of work complexity metrics 168 are illustrated as being contained within the main memory 102, these elements are not necessarily all completely contained in the same storage device at the same time. Further, although the application server 160, the compiler 162, the page 164, the dependency graph 166, and the unit of work complexity metrics 168 are illustrated as being separate entities, in other embodiments some of them, or portions of some of them, may be packaged together.

In an embodiment, the application server 160 is a component-based product that resides in the middle-tier of a server-centric architecture. The application server 160 may provide middleware services for security and state maintenance, along with data access and persistence. In an embodiment, the application server 160 is a Java application server based on the Java 2 Platform, Enterprise Edition (J2EE), but in other embodiments any appropriate platform may be used. J2EE uses a multi-tier distributed model, which generally includes a client tier, a middle tier, and an EIS (Enterprise Information System) tier. The client tier can be one or more applications or browsers. The J2EE Platform is in the middle tier and consists of a web server and an EJB (Enterprise Java Beans) server. (These servers are also called “containers.”) Additional sub-tiers in the middle tier may also exist. The EIS tier has the existing applications, files, and databases. For the storage of business data, the J2EE platform uses a database that is accessible through a JDBC (Java Database Connectivity), SQLJ (Structured Query Language for Java), or JDO API (Java Data Objects Application Program Interface). The database may be accessible from web components, enterprise beans, and application client components.

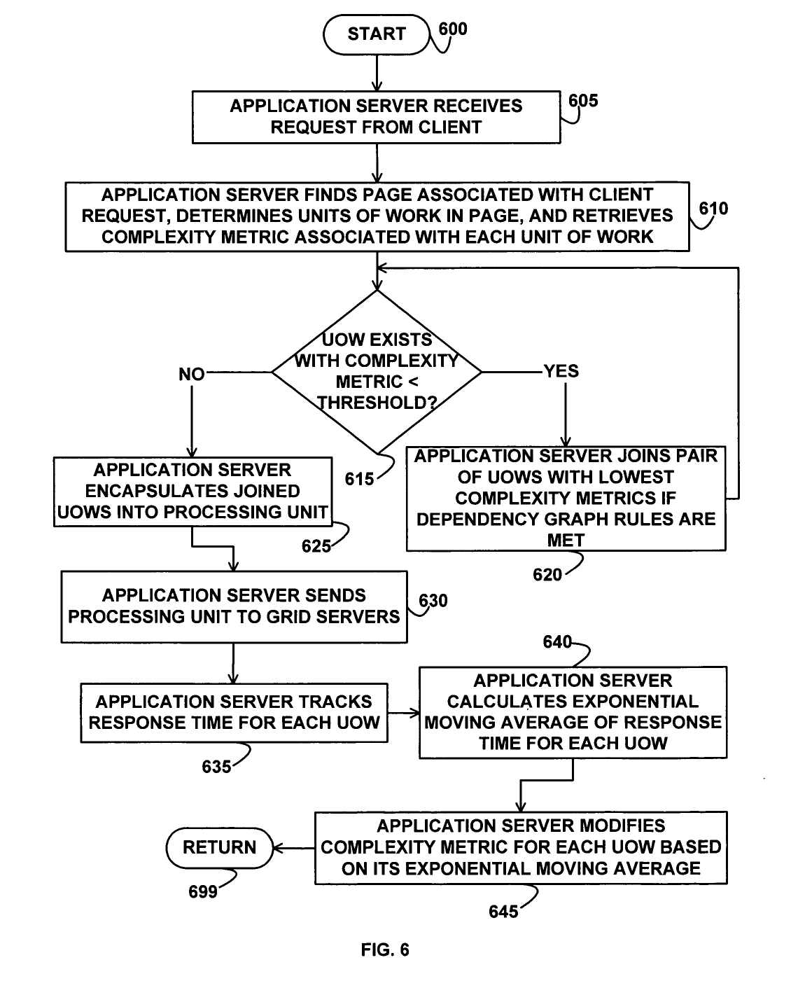

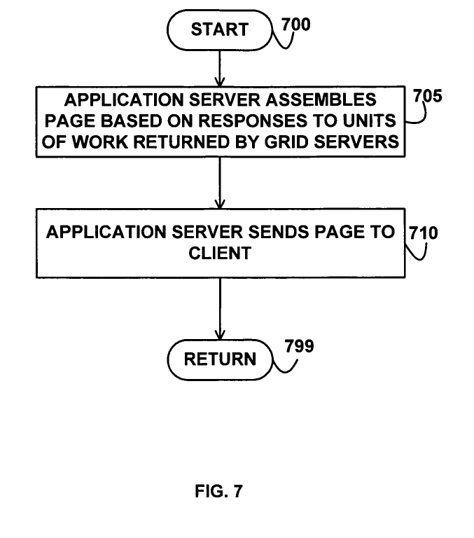

The application server 160 responds to requests from the client 132 by sending the units of work 172 to the grid servers 133, assembling the page 164 based on the responses from the grid servers 133, and sending the assembled page to the client 132. The application server 160 includes instructions capable of executing on the processor 101 or statements capable of being interpreted by instructions executing on the processor 101 to perform the functions as further described below with reference to FIGS. 6 and 7. In another embodiment, the application server 160 may be implemented in microcode or firmware. In another embodiment, the application server 160 may be implemented in hardware via logic gates and/or other appropriate hardware techniques in lieu of or in addition to a processor-based system.

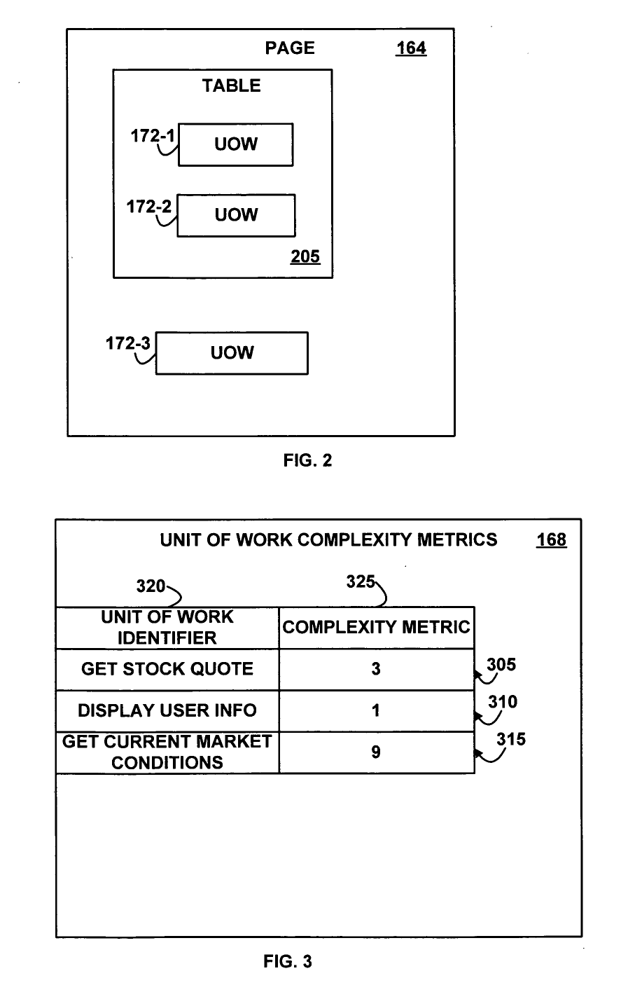

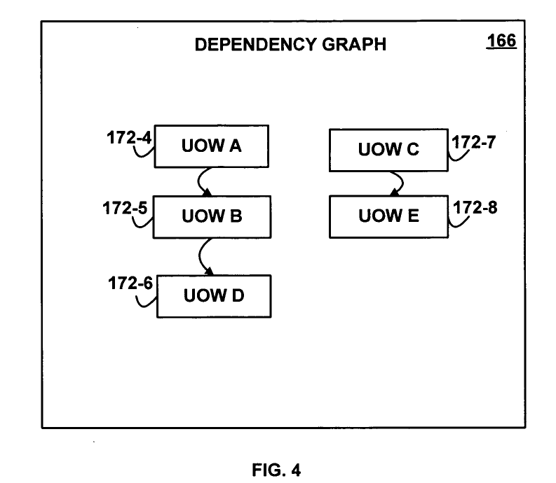

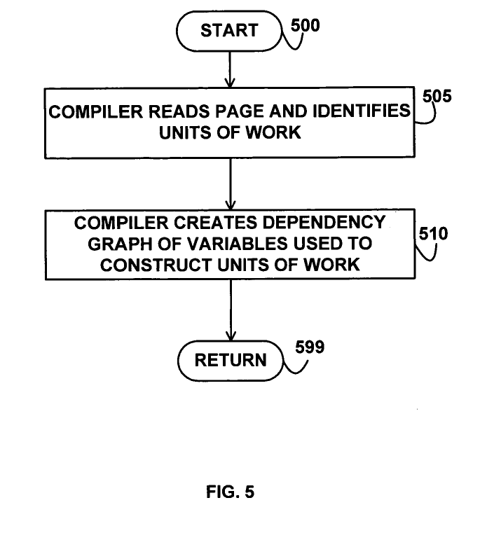

The page 164 includes a unit of work 172. In various embodiment, the unit of work 172 may be a section or a cell in a table or any other work capable of being processed by a grid server 133. The page 164 is further described below with reference to FIG. 2. The compiler 162 reads the page 164, identifies the units of work 172, and creates the dependency graph 166. The compiler is further described below with reference to FIG. 5. The dependency graph 166 indicates the data dependency relations between the units of work 172. The dependency graph 166 is further described below with reference to FIG. 4. The unit of work complexity metrics 168 indicate the complexity of processing the various units of work 172. The unit of work complexity metrics 168 are further described below with reference to FIG. 3.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The client 132 and the grid servers 133 may include some or all of the hardware and/or software elements previously described above for the computer system 100. The client 132 sends a request to the computer system 100. The grid servers 133 execute units of work sent from the application server 160. Although the client 132 and the grid servers 133 are illustrated as being separate from the computer system 100, in another embodiment some or all of them may be a part of the computer system 100.

Together, the application server 160 and the grid servers 133 implement a technique that is often called grid computing. In grid computing, a grid controller, such as the application server 160, breaks up a task, such as assembling the page 164 into multiple, smaller units of work (UOW), such as the units of work 172. The application server 160 then sends each unit of work 172 to multiple receiving computers (the grid servers 133) in parallel via the network 130 for execution. Some of these receiving grid servers 133 may execute the unit of work 172 and send the results back quickly. Other of the receiving grid servers 133 may execute the unit of work 172 and send the results back more slowly. Still others may never receive the unit of work 172, receive the unit of work 172 but never execute it, or execute unit of work 172 but never send the results back. The application server 160 uses the first results that are returned for a particular unit of work 172 and ignores the other, later results. In addition to the benefit of saving money by using the resources of the grid servers 133 (which may be otherwise underutilized), grid computing also has the advantage of performance benefits, by breaking up a large task into many smaller units of work and executing them in parallel.

It should be understood that FIG. 1 is intended to depict the representative major components of the computer system 100, the network 130, the client 132, and the grid servers 133 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible signal-bearing media, which include, but are not limited to the following computer-readable media:

(1) information permanently stored on a non-rewriteable storage medium, e.g., a read-only memory storage device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications or transmissions medium, such as through a computer or a telephone network, e.g., the network 130.

Such tangible signal-bearing media, when carrying or encoded with computer-readable, processor-readable, or machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example page 164, according to an embodiment of the invention. The example page 164 includes units of work 172-1, 172-2, and 172-3, which represent examples of the units of work 172, but in other embodiments any number of units of work 172 may be present. In an embodiment, the page 164 may include a table 205, which may be broken up into sections or cells, each of which may be a unit of work, such as the units of work 172-1 and 172-2. But, in another embodiment, the units of work may exist independently of a table, such as the unit of work 172-3. Sections of a page may be any content that are logically related to each other, such as menus, news, utilities, or any other appropriate content. Thus, in various embodiments, the units of work 172 may be database queries, sections, cells, menus, widgets, or any other appropriate portion of the page 164 that is capable of being sent to and processed by one or more of the grid servers 133.

The page 164 may be implemented via the HTML (Hypertext Markup Language), Java Server Pages (JSP), and servlets. In various other embodiments, the page 164 may be implemented via Active Server Pages (ASP), CGI (Common Gateway Interface) scripts, ISAPI (Internet Server Application Programming Interface), NSAPI (Netscape Server Application Programming Interface), or any other appropriate technology.

FIG. 3 depicts a block diagram of example unit of work complexity metrics 168, according to an embodiment of the invention. The example unit of work complexity metrics 168 include records 305, 310, and 315, but in other embodiments any number of records with any appropriate data may be present. Each of the records 305, 310, and 315 includes a unit of work identifier field 320 and a complexity metric field 325, but in other embodiments more or fewer fields may be present. The unit of work identifier field 320 identifies a unit of work 172. The complexity metric 325 includes a value that reflects the complexity of performing the unit of work 172 identified by the associated unit of work identifier 320 in its respective record. In an embodiment, the complexity metric may be relative or scaled, such as on a scale from 1 to 10 or 1 to 100. For example, the complexity metric 325 may be proportional to the actual or estimated number of actions, transactions, processor cycles, or amount of time necessary to perform the unit of work 320, or any relative measure of difficulty, time, throughput, or complexity. In another embodiment, the complexity metric 325 may be absolute and indicate the actual or estimated number of actions, transactions, processor cycles, or amount of time necessary to perform the unit of work 320, or any other absolute measure of difficulty, time, throughput, or complexity.

FIG. 4 depicts a block diagram of an example dependency graph 166, according to an embodiment of the invention. The dependency graph 166 indicates the data dependency relations between the example units of work 172-4, 172-5, 176-6, 172-7, and 172-8, which are generically referred to as units of work 172 (FIG. 1). The dependency graph 166 includes nodes corresponding to the units of work and edges (arrows or directed edges) corresponding to the dependency relations for each of the units of work. The unit of work A 172-4 is dependent on the unit of work B 172-5, which is in turn dependent on the unit of work D 172-6. Similarly, the unit of work C 172-7 is dependent on the unit of work E 172-8.

Dependency means that a particular unit of work 172 needs the results of the unit of work on which it depends, such as created data, register values, or files. Rules for combining the units of work 172 may be inferred from the dependency graph 166. For example, the unit of work A 172-4 and the unit of work C 172-7 may be combined into a new unit of work because they have no dependencies that conflict. But, the unit of work A 172-4 and the unit of work D 172-6 may not be combined without also including the unit of work B 172-5 since the unit of work A 172-4 is dependent on the unit of work B 172-5, which is dependent on the unit of work D 172-6. Although the dependency graph is visually shown in FIG. 4 for the sake of a convenient explanation, the dependency graph 166 is not a picture, but a group of data composed of nodes and edges.

FIG. 5 depicts a flowchart of example processing for the compiler 162, according to an embodiment of the invention. Control begins at block 500. Control then continues to block 505 where the compiler 162 reads the page 164 and identifies the units of work 172. Control then continues to block 510 where the compiler 162 creates the dependency graph 166 of variables used to construct the units of work 172, as previously described above with reference to FIG. 4. Control then continues to block 599 where the logic of FIG. 5 returns.

FIG. 6 depicts a flowchart of example processing for handling a request from a client 132, according to an embodiment of the invention. Control begins at block 600. Control then continues to block 605 where the application server 160 receives a request sent from the client 132. Control then continues to block 610 where the application server 160 finds the page 164 associated with the request from the client 132, determines the units of work 172 in the page 164, and retrieves the complexity metric 325 associated with each unit of work 172.

Control then continues to block 615 where the application server 160 determines whether a unit of work 172 exists in the page 164 with a complexity metric 325 less than a threshold. If the determination at block 615 is true, then a unit of work 172 exists in the page 164 with a complexity metric 325 less than the threshold, so control continues to block 620 where the application server 160 joins two units of work 172 (a pair) with the lowest complexity metrics 325 into a new unit of work if the rules of the dependency graph 166 are met. Control then returns to block 615, as previously described above. Thus, the application server 160 combines the units of work 172 until all units of work 172 have a complexity metric 325 less than the threshold, so long as the rules of the dependency graph 166 are met.

If the determination at block 615 is false, then a unit of work 172 does not exist in the page 164 with a complexity metric 325 less than the threshold, so control continues to block 625 where the application server 160 encapsulates the joined units of work into a processing unit. Control then continues to block 630 where the application server 160 sends the processing unit in parallel to the grid servers 133. Control then continues to block 635 where the application server 160 tracks the response time of each unit of work 172 from the grid servers 133.

Control then continues to block 640 where the application server 160 calculates the exponential moving average of the response time from the grid servers 133 for each unit of work 172. A simple moving average is calculated by adding the response times over a given number of periods, then dividing the sum by the number of periods. For example, a nine-day simple moving average would add together the response times for the last nine days, and then divide that number by nine. In contrast, an exponential moving average gives more weight to recent response times, and is calculated by applying a percentage of the current time period's response time to a previous time period's moving average. The longer the period of the exponential moving average, the less total weight is applied to the most recent response time. The advantage to an exponential average is its ability to detect response time changes more quickly.

Control then continues to block 645 where the application server 160 modifies the complexity metric 325 for each unit of work 172 based on the exponential moving average of the unit of work 172. In an embodiment, the application server 160 sets the complexity metric 325 to be the exponential moving average of the unit of work 172. Control then continues to block 699 where the logic of FIG. 6 returns.

FIG. 7 depicts a flowchart of example processing for assembling the page 164, according to an embodiment of the invention. Control begins at block 700. Control then continues to block 705 where the application server 160 assembles the page 164 based on the responses to the units of work 172 returned by the grid servers 133. Control then continues to block 710 where the application server 160 sends the assembled page 164 to the client 132. Control then continues to block 799 where the logic of FIG. 7 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
determining a plurality of units of work in a page;
joining selected pairs of the units of work until all of the units of work have associated complexity metrics that are less than a threshold;
encapsulating the joined selected pairs into a processing unit; and
sending the processing unit to a plurality of grid servers.

2. The method of claim 1, wherein the joining further comprises:
joining the selected pairs if rules of a dependency graph are met.

3. The method of claim 2, wherein the dependency graph indicates data dependency relationship of the plurality of units of work.

4. The method of claim 1, wherein the joining further comprises:
determining the selected pairs with lowest of the complexity metrics.

5. The method of claim 1, further comprising:
modifying the complexity metrics based on response times of the plurality of units of work.

6. The method of claim 5, wherein the modifying further comprises:
modifying the complexity metrics based on an exponential moving average of the response times.

7. The method of claim 1, further comprising:
assembling the page based on responses from the grid servers, wherein the responses comprise dynamic content for the page.

8. A signal-bearing medium encoded with instructions, wherein the instructions when executed comprise:
determining a plurality of units of work in a page;
joining selected pairs of the units of work until all of the units of work have associated complexity metrics that are less than a threshold;
encapsulating the joined selected pairs into a processing unit; and
sending the processing unit to a plurality of grid servers.

9. The signal-bearing medium of claim 8, wherein the joining further comprises:
joining the selected pairs if rules of a dependency graph are met.

10. The signal-bearing medium of claim 9, wherein the dependency graph indicates data dependency relationship of the plurality of units of work.

11. The signal-bearing medium of claim 8, wherein the joining further comprises:
determining the selected pairs with lowest of the complexity metrics.

12. The signal-bearing medium of claim 8, further comprising:
modifying the complexity metrics based on response times of the plurality of units of work.

13. The signal-bearing medium of claim 12, wherein the modifying further comprises:
modifying the complexity metrics based on an exponential moving average of the response times.

14. The signal-bearing medium of claim 8, further comprising:
assembling the page based on responses from the grid servers, wherein the responses comprise dynamic content for the page.

15. A method for configuring a computer, comprising:
configuring the computer to determine a plurality of units of work in a page;
configuring the computer to join selected pairs of the units of work until all of the units of work have associated complexity metrics that are less than a threshold;
configuring the computer to encapsulate the joined selected pairs into a processing unit;
configuring the computer to send the processing unit to a plurality of grid servers; and
configuring the computer to assemble the page based on responses from the grid servers, wherein the responses comprise dynamic content for the page.

16. The method of claim 15 wherein the configuring the computer to join further comprises:
configuring the computer to join the selected pairs if rules of a dependency graph are met.

17. The method of claim 16, wherein the dependency graph indicates data dependency relationship of the plurality of units of work.

18. The method of claim 15 wherein the configuring the computer to join further comprises:
configuring the computer to determine the selected pairs with lowest of the complexity metrics.

19. The method of claim 15, further comprising:
configuring the computer to modify the complexity metrics based on response times of the plurality of units of work.

20. The method of claim 19, wherein the configuring the computer to modify further comprises:
configuring the computer to modify the complexity metrics based on an exponential moving average of the response times.
